(19) United States
(12) Patent Application Publication
(10) Pub. No.: US 2024/0095058 A1
(43) Pub. Date: Mar. 21, 2024

(54) SYSTEM AND METHOD FOR SELF-HEALING AGENT AND CLOUD DESKTOP

(71) Applicant: Workspot, Inc., Campbell, CA (US)

(72) Inventors: Anushree Kunal Pole, Sunnyvale, CA (US); Jimmy Chang, Mountain View, CA (US); Amitabh Bhuvangyan Sinha, San Jose, CA (US); David T. Sulcer, Pacifica, CA (US)

(21) Appl. No.: 18/468,153

(22) Filed: Sep. 15, 2023

Related U.S. Application Data
(60) Provisional application No. 63/375,805, filed on Sep. 15, 2022.

(51) Int. Cl. G06F 9/455

(52) U.S. Cl. CPC G06F 9/45558; G06F 2009/4557; G06F 2009/45595

(57) ABSTRACT

A virtual desktop system includes one or more virtual desktops, associated cloud infrastructure, and a control plane configured to manage a life cycle of the one or more virtual desktops on the cloud infrastructure. The cloud infrastructure is configured to: (i) receive a first configurable set of rules from the control plane, (ii) store the first configurable set of rules, (iii) evaluate the first configurable set of rules to determine whether conditions associated with one or more rules are met, (iv) based on the conditions being met, perform one or more actions to execute the one or more rules, and (v) provide diagnostics related to the one or more executed rules to the control plane for further analysis.

### PRIORITY CLAIM

This application claims priority to U.S. Provisional Application No. 63/375,805, filed on Sep. 15, 2022. The entirety of that application is hereby incorporated by reference.

### TECHNICAL FIELD

The present disclosure relates generally to network-based virtual desktop systems. More particularly, aspects of this disclosure relate to a system that provides dynamic self-healing associated with one or more virtual desktops.

### BACKGROUND

Computing systems that rely on applications operated by numerous networked computers are ubiquitous. Information technology (IT) service providers thus must effectively manage and maintain very large-scale infrastructures, and centrally coordinating management of infrastructure in both physical and virtual space can be a daunting task. An example enterprise environment may have many thousands of devices and hundreds of installed software applications to support. The typical enterprise also uses many different types of central data processors, networking devices, operating systems, storage services, data backup solutions, cloud services, and other resources. These resources are often provided by means of cloud computing, which is the on-demand availability of computer system resources, such as data storage and computing power, over the public internet or other networks without direct active management by the user.

Users of networked computers such as in a cloud-based system may typically log into a computer workstation or client device and are provided a desktop application that displays an interface of applications and data available via the network or cloud. As a user is connected to or can access the applications and data, problematic events may derail the desktop session. There is a need for a cloud-based system that can troubleshoot or perform actions to mitigate effect(s) of these problematic events with little orchestration from a centralized entity or from the user. A more decentralized approach to handling problematic events can improve overall responsiveness of cloud-based systems.

### SUMMARY

Some implementations of the present disclosure provide a virtual desktop system. The virtual desktop includes one or more virtual desktops and associated public or private cloud infrastructure. The system further includes a control plane configured to manage a life cycle of the one or more virtual desktops on the cloud infrastructure. The cloud infrastructure is configured to receive a first configurable set of rules from the control plane. The cloud infrastructure is further configured to store the first configurable set of rules and evaluate the first configurable set of rules to determine whether conditions associated with one or more rules are met. The cloud infrastructure is further configured to perform one or more actions to execute the one or more rules based on the conditions being met. The cloud infrastructure is further configured to provide diagnostics related to the one or more executed rules to the control plane for further analysis.

Some implementations of the present disclosure provide a method for managing a virtual desktop. The method includes receiving, by a public or a private cloud infrastructure associated with the virtual desktop, a first configurable set of rules from a control plane. The method further includes storing, by the cloud infrastructure, the first configurable set of rules. An agent of the cloud infrastructure evaluates the first configurable set of rules to determine whether conditions associated with one or more rules are met. Based on the conditions being met, the agent performs one or more actions to execute the one or more rules. The agent provides diagnostics related to the one or more executed rules to the control plane for further analysis.

Some implementations of the present disclosure provide a non-transitory computer-readable medium having machine-readable instructions stored thereon, which when executed by a processor, cause the processor to: (i) receive, by a public or private cloud infrastructure associated with a virtual desktop, a first configurable set of rules from a control plane; (ii) store, by the cloud infrastructure, the first configurable set of rules; (iii) evaluate, by an agent of the cloud infrastructure, the first configurable set of rules to determine whether conditions associated with one or more rules are met; (iv) based on the conditions being met, perform, by the agent, one or more actions to execute the one or more rules; and (v) provide, by the agent, diagnostics related to the one or more executed rules to the control plane for further analysis.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a high-level block diagram illustrating an example cloud desktop fabric allowing access to virtual desktops globally;

FIG. 2 is a block diagram of a cloud region and desktop service control plane of the example cloud desktop fabric in FIG. 1;

FIG. 3 illustrates a flow diagram for providing rules to agents in the cloud region, according to some implementations of the present disclosure;

FIG. 4 illustrates a flow diagram for how agents can manage events in the cloud region, according to some implementations of the present disclosure;

FIG. 5 illustrates a first exemplary system in accordance with various examples of the present disclosure; and

FIG. 6 illustrates a second exemplary system in accordance with various examples of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure relates to a distributed network of desktop service capabilities that can be centrally administered and managed. The system is elastic, which allows the ability to provide desktop resources from multiple cloud regions that meet desktop requirements for a user in a dynamic way. The distributed cloud desktop service is responsible for maintaining gateways, desktop virtual machines, and other cloud-based resources in a running state. Typically, there is a software agent application (i.e., agent) deployed on every gateway and desktop virtual machine that is responsible to report run-time status and perform remote operations on the virtual machine (e.g., reboot, install operating system patches, etc.). Typically, a desktop service control plane of the distributed cloud desktop service orchestrates the activities of each agent. In some situations, problems can develop while the agent does not have connectivity to the desktop service control plane. For this and other reasons, there is a need for the agent to perform diagnostic and repair operations independently of the desktop service control plane.

In some aspects of the present disclosure, the distributed cloud desktop service provides agents with a configurable set of rules to alleviate some coordination efforts required by the desktop service control plane. The example system ensures that agents can handle one or more events that occur during operation using the configurable set of rules. The rules are defined by desktop service administrators and stored in a location available to be copied to each agent while the agent is operating normally. Different sets of rules may be targeted to different groups of agents. For example, some rules may only apply to gateway agents for a particular customer, and some rules may apply to all virtual machines in a particular region. With the configurable set of rules, the agents can perform quick actions to resolve errors independently of the desktop service control plane. Diagnostics and results of actions taken by the agents can be later provided to the desktop service control plane.

The following are definitions of terms used in this disclosure that relate in general to the virtual desktop system.

An agent is software that performs certain operations and monitoring tasks that has direct access to, or runs on, some virtual computing resource and may maintain a duplex communication channel with a desktop service control plane.

An API is a set of specific, controlled, well-defined functional entry points to get, create, update, and delete resources and otherwise change the state of a remote system.

A cloud API is, in this context, an API specific to a cloud service provider.

A connection broker is desktop service resource sometimes used to dynamically connect desktop clients with desktops.

A cloud provider, also known as a cloud service provider, in this context, is an Infrastructure as a Service provider (IaaS) that provides virtual machines as a service in one or more cloud regions.

A cloud region is a collection of computing resources, such as virtual machine hosts, virtual networks, virtual storage devices, protocol gateways, servers, or other infrastructure in one physical location. The virtual resources are abstractions available to cloud customers, actually implemented by physical hardware such as networking equipment including but not limited to routers, hubs, switches, persistent storage devices such as disks, CPU and/or GPU processors, random access memory (RAM), security appliances including firewalls, operating system software, and other components that may be employed in a cloud regional data center to provide a hosting environment for virtual machines, sometimes known as a “server”, “host”, or “node.” A cloud region is typically described as being part of a public cloud, all the descriptions of the functionality apply equally to a private cloud whose availability is restricted to certain organizations.

A cloud availability zone is an isolated location within a cloud region, with some services that are redundant to other cloud availability zones within the same cloud region, in order to provide a higher level of availability in the event of an outage in a one location. A cloud service provider may allow resources such as virtual machines to be provisioned in a multiple specific availability zones, or may manage logical resources to be spread across availability zones automatically based on availability requirements, such as requiring that cloud resources are still available in the event of a power outage in one zone.

A virtual desktop is the information and capability needed to instantiate and manage, whenever needed, a specific virtual machine providing interactive desktop software or applications, or other experiences provided by remote desktop virtualization via a desktop service utilizing a cloud region.

A pool is a configuration object that describes a collection of virtual desktops, that is associated with a group of cloud desktop users, and certain attributes they have in common. For example, it may describe the common icon image used to launch a desktop.

A pool is a configuration object that describes a collection of virtual desktops, that is associated with a group of cloud desktop users, and certain attributes they have in common. For example, it may describe the common icon image used to launch a desktop.

A client, or desktop client (sometimes called a VDI client) is a software application that provides display and input access to a desktop as part of a desktop service. It may be installed on a standard desktop or mobile operating system, or be pre-installed on dedicated hardware devices, or downloaded dynamically via a web browser application, or deployed in some other way. Like an agent, it may also perform certain operations and monitoring tasks and may maintain a duplex communication channel with a desktop service control plane.

A cloud desktop fabric is a scalable virtual desktop interface system that orchestrates multiple regional fabric regions to allow a user anywhere to access a virtual desktop interface.

A desktop service resource refers to some virtualized hardware, networking service, or virtual machine, other than the desktops themselves, that exists to support a desktop service for use by cloud desktop users.

A desktop service is remote desktop virtualization hosted on a public or private cloud, provided as a turnkey managed service.

A desktop service control plane is an application that implements and manages a desktop service.

A cloud desktop user, also referred to as user, is a person who uses a cloud desktop.

An enterprise connector is a desktop service resource used to integrate the network of a desktop service with the network services, including but not limited to directory services that support authentication and authorization.

A gateway, sometimes referred to as a protocol gateway, is a type of desktop service resource running a service that manages secure access to a desktop supporting protocols including a remote display protocol (RDP). In this disclosure, gateways are accessed as a gateway cluster unless explicitly noted otherwise.

A gateway cluster is a set of gateways managed together for load balancing purposes.

Infrastructure as a service (IaaS) is a set of virtualized computing resources available from a cloud service provider.

An infrastructure template is a collection of desktop service resources and/or definitions that provide a blueprint for replicating a cloud region's resources.

A multi-tenant desktop service control plane is a single desktop service control plane implementation that is used by multiple customers in such a way that no single customer is aware of or is impacted by activities of the others.

The term “near-real-time” refers to the processing timeframe of a system in which root cause information is produced without significant delay, close enough in time from the triggering events to be acted upon immediately to achieve business goals, typically measured as under one minute.

A non-persistent desktop user is a desktop user that is allocated a new desktop for each login session.

A persistent desktop user is a desktop user that is allocated a specific desktop for exclusive use over multiple connection sessions.

Pool desktops are a set of desktops managed by the desktop service control plane as a unit.

Remote desktop virtualization is software technology that separates the desktop environment and associated application software from the physical client device that is used to access it in a client/server environment.

A virtual application is the capability to access a user experience for a particular application running remotely.

A virtualized computing resource is a virtual machine that is created by an Infrastructure as a Service (IaaS) provider.

A virtual machine is an emulation of a physical computer that can be accessed over a network.

A virtual network is hardware and software network resources combined into a single, software-based administrative entity, made available by an Infrastructure as a Service (IaaS) provider.

Virtual storage is storage resources provided as part of Infrastructure as a Service.

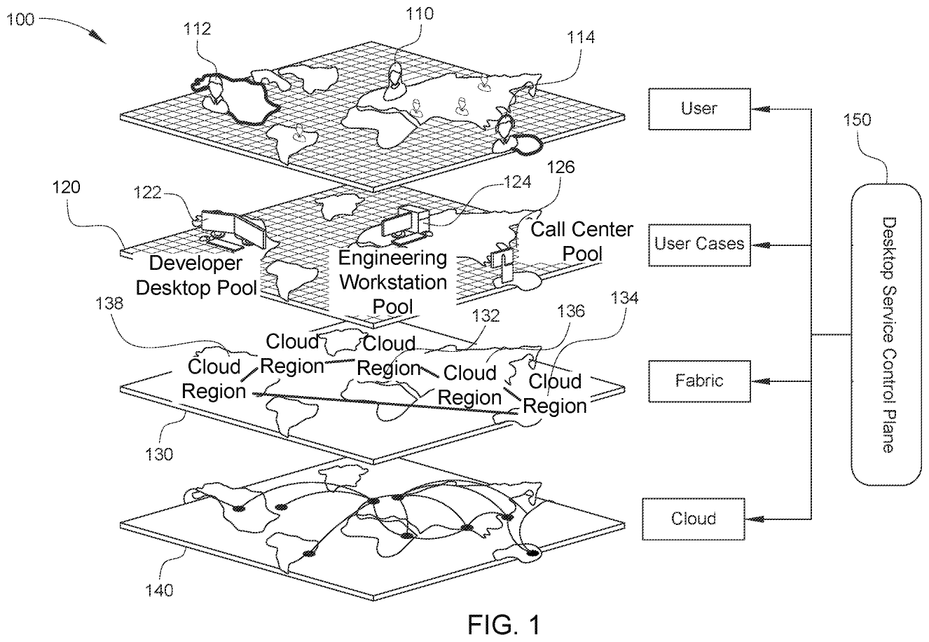

FIG. 1 shows a high level block diagram of a cloud desktop service system 100. The cloud desktop service system 100 may also be referenced as a global desktop system because it provides virtual desktops for users globally. The cloud desktop service system 100 includes four layers: a users layer 110, a use cases layer 120, a fabric layer 130, and a cloud layer 140.

The users layer 110 represents desktop users having the same computing needs, that may be located anywhere in the world. In this example, the users layer 110 includes users 112 and 114, who are in geographically remote locations and access desktops via computing devices.

The use cases layer 120 represents common pools of desktops available to serve the users, whereby each pool may be based on common desktop requirements. There can be multiple pools based on which groups users belong to and their job requirements. In this example, the pool for the users 112 and 114 may be one of a developer desktop pool 122, an engineering workstation pool 124, or a call center application pool 126. The desktops each include configuration and definitions of resources necessary to offer the desktop.

For example, pools such as the developer desktop pool 122 or the engineering workstation pool 124 allow users in the pool a desktop that allows access to graphic processing unit (GPU) based applications. Other example applications may include those applications used for the business of the enterprise, for example, ERP (enterprise resource planning) applications or CRM (customer relationship management) applications. These applications allow users to control the inventory of the business, sales, workflow, shipping, payment, product planning, cost analysis, interactions with customers, and so on. Applications associated with an enterprise may include productivity applications, for example, word processing applications, search applications, document viewers, and collaboration applications. Applications associated with an enterprise may also include applications that allow communication between people, for example, email, messaging, web meetings, and so on.

The fabric layer 130 includes definitions and configurations for infrastructure and desktop service resources, including gateways, desktop templates, and others that are applied to cloud regions. The resources are maintained as cloud regions such as cloud region 132, 134, 136, and 138. The cloud regions can be added or removed as needed.

The cloud layer 140 implements the resources defined by the use case layer 120 and fabric layer 130, including virtual desktops, infrastructure, and other virtual resources, all of which are virtual machines or other virtual resources hosted in a public or private cloud.

The layers 110, 120, 130, and 140 are created and orchestrated by a desktop service control plane 150 that can touch all the layers. The desktop service control plane 150 is a key component to orchestrate a cloud desktop service system such as the cloud desktop service system 100 in FIG. 1. The desktop service control plane 150 can manage the entire lifecycle of a desktop service implementation, from creating and managing the required desktops, to monitoring and analyzing the stream of operational data collected, enforcing security policies, and optimizing the experience for IT administrators and desktop users. For example, the desktop service control plane 150 may register a set of a virtual networks, virtual storage resources, and more. Within a virtual network, the control plane 150 may further register and coordinate the use of gateways, enterprise connectors, desktop templates, connection brokers, and more. In some implementations of the present disclosure, the control plane 150 provides a configurable set of rules to virtual machines in the cloud regions, enabling the different virtual machines to self-manage specific events that would have been previously orchestrated by the control plane 150.

The two cloud desktop users 112 and 114 in different parts of the world who are each able to access an example high-performance desktop service from the cloud desktop service system 100. The cloud desktop service system 100 eliminates the need to divide cloud users with similar requirements into user groups specific to a region. In some implementations, all users having similar needs throughout the world are considered as a single worker pool. Cloud desktop users, such as cloud desktop users 112 and 114, each may use a client device to access the desktop service. Client devices may be any device having computing and network functionality, such as a laptop computer, desktop computer, smartphone, or tablet. Client devices execute a desktop client to access remote applications such as the desktop. The client application authenticates user access to the applications. A client device can be a conventional computer system executing, for example, a Microsoft™ Windows™-compatible operating system (OS), Apple™ OS X, and/or a Linux distribution. A client device can also be a client device having computer functionality, such as a personal digital assistant (PDA), mobile telephone, tablet, video game system, etc. In this example, the client application displays an icon of the desktop or desktops available to the user. As will be explained, the desktop is made available to the user through the client application on the user device.

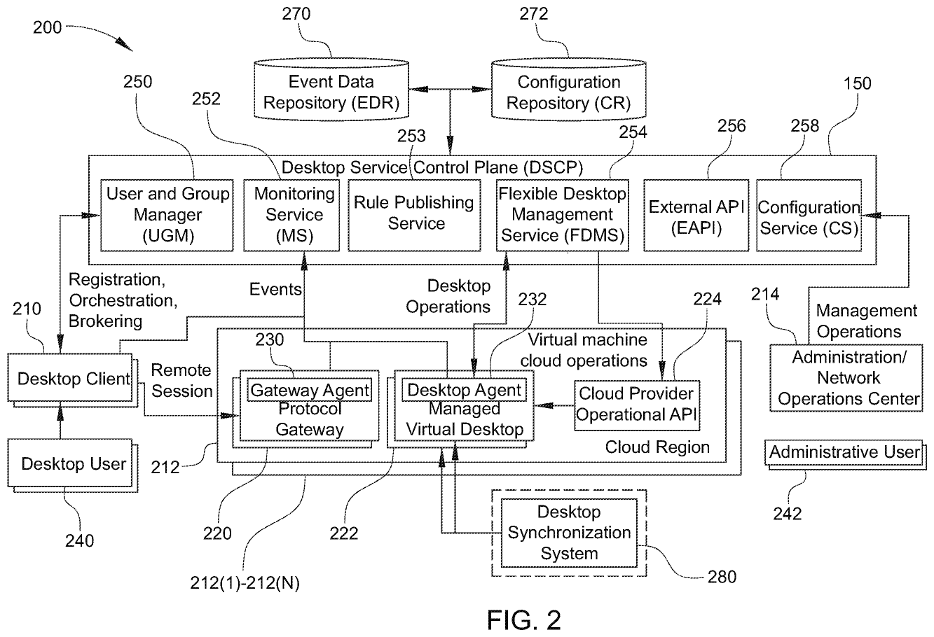

FIG. 2 is a block diagram of some examples of components of the cloud desktop service system 100, including an example set of desktop clients 210, a cloud region 212, and an administration center 214, that interact with and can be orchestrated by the desktop service control plane 150. The desktop client 210 communicates with the desktop service control plane 150 in order to be registered with the fabric, assigned a desktop, remotely configured, and for other purposes. There may be multiple cloud regions (e.g., cloud regions 212(1) to 212(N)) similar to the cloud region 212, but only one cloud region 212 is shown in detail for simplicity of explanation. The cloud region 212 may include a set of protocol gateways 220, a set of managed cloud desktops 222, and a cloud service provider operational API 224. These components all communicate with the desktop service control plane 150. The cloud region 212 may support one of the fabric regions 132, 134, 136, and 138 in FIG. 1.

Such cloud regions include servers that host the various applications as well as appropriate storage capabilities, such as virtual disks, memory, and network devices. Thus, the cloud region 212 typically comprises IT infrastructure that is managed by IT personnel. The IT infrastructure may include servers, network infrastructure, memory devices, software including operating systems, and so on. If there is an issue related to an application reported by a user, the IT personnel can check the health of the infrastructure used by the application. A cloud region may include a firewall to control access to the applications hosted by the cloud region. The firewall enables computing devices behind the firewall to access the applications hosted by the cloud region but prevents computing devices outside the firewall from directly accessing the applications. The firewall may allow devices outside the firewall to access the applications within the firewall using a virtual private network (VPN).

The protocol gateway 220 may be present to provide secure public or internal limited access to the managed virtual desktops, that may be deployed on a virtual machine of its own. A gateway agent 230 is software that is deployed on that gateway virtual machine by the desktop service control plane 150, and serves to monitor the activity on the gateway 220, and enable the desktop service control plane 150 to assist in configuration and operations management of the gateway 220. In some implementations, the gateway agent 230 performs management of the gateway 220 based on configurable rules (e.g., gateway management rules) received from the desktop service control plane 150. Rule publishing service 253 of the desktop service control plane 150 can publish the configurable rules to the gateway 220 such that the gateway agent 230 has access to the configurable rules.

The example desktop client 210 is software and device hardware available in the local environment of a desktop user 240 to remotely access a managed virtual desktop using a remote desktop protocol. The desktop client 210 communicates with the desktop service control plane 150 and also supports a remote display protocol in order for users to connect to a desktop application run by the cloud region 212.

The managed virtual desktop 222 is itself provisioned and can be maintained by the desktop service control plane 150. A desktop template may be used to manage pools of such managed virtual desktops. A desktop agent such as desktop agent 232 is software that is deployed on that managed virtual desktop by the desktop service control plane 150, and serves to monitor the activity on the managed virtual desktop, and enable the desktop service control plane 150 to assist in configuration and operations management of the managed virtual desktop. In some implementations, the desktop agent 232 performs maintenance on the managed virtual desktop 222 based on configurable rules (e.g., desktop management rules) received from the desktop service control plane 150. The rule publishing service 253 of the desktop service control plane 150 can publish the configurable rules to the managed virtual desktop 222 such that the desktop agent 232 has access to the configurable rules.

The cloud service provider operational application programming interface (API) 224 presents services provided by the cloud service provider that also participate in the management of the virtual machine. This can be utilized by the desktop service control plane 150 to perform operations like provisioning or de-provisioning the virtual machine.

Administrative users 242 can interact with operations reporting interface software at the administration center 214 that allows management and administration of the desktop service control plane 150.

Other components and services may interact with the desktop service control plane but are omitted from FIG. 2 for simplicity, such as enterprise connectors, network monitoring services, customer relationship management (CRM) systems, and many others.

The desktop service control plane 150 itself can perform many internal centralized functions also not depicted in in FIG. 2, including pool management, user and group management, cloud service adapters, virtual desktop templates, data analysis, high-availability management, mapping users to the optimal cloud region, security policy management, monitoring, compliance, reporting, and others.

The control plane 150 includes a user and group manager 250, a monitoring service 252, a flexible desktop management service (DMS) 254, an external API (EAPI) 256, and a configuration service (CS) 258. The control plane 150 may access an event data repository 270 and a configuration repository 272. In some implementations, the configuration repository 272 includes the configurable rules provided by the administration center 214. In some implementations, the configurable rules are stored in the control plane 150. Although only one cloud region 212 is shown in detail, it is to be understood that the control plane 150 may facilitate numerous cloud regions.

The monitoring service 252 makes both routine and error events available to administrators and can analyze operational performance and reliability. The monitoring service 252 interacts with components including the desktop client 210, gateway agent 230, desktop agent 232, and those generated by the control plane 150 itself. The flexible desktop management service 254 interacts with the one or more managed virtual machines (MVMs) 222 in the cloud region 212 and other regional cloud regions 212(1) to 212(N). In some implementations, the flexible desktop management service 254 manages resources for providing virtual desktops to the users in the pools, orchestrating the lifecycle of a logical desktop. In some implementations, multiple virtual desktops for the same logical desktop may be created by the flexible desktop management system 254 to ensure the virtual desktop accessed by a user operates optimally by changing the selection of the virtual desktop in response to changes in conditions.

The administration center 214 works directly with the data control plane 150 as its primary human interface. The administration center 214 allows the administrative user 242 to configure the functions of the control plane 150 through the configuration service 258. The configuration service 258 supports editing and persistence of definitions about the desktop service, including subscription information and policies. The administration center 214 may be where parameters for the configurable rules are set by the administrative user 242. The administrative user 242 can further set and classify the configurable rules such that some rules only apply to gateway agents (e.g., the gateway agent 230) and some rules only apply to desktop agents (e.g., the desktop agent 232).

The system 200 in FIG. 2 allows the gateway agent 230 and/or the desktop agent 232 to manage operation of the gateway 220 and/or the virtual desktop 232, respectively, using configurable rules. Configurable rules may be directed at health check services, networking services, power management services, system operations, versioning, network performance, or other management services.

In some implementations, different sets of rules may be targeted to different agents. For example, two users may be working on two different virtual desktops. Each virtual desktop has its own desktop agent such that configurable rules applicable to one desktop agent may be different from configurable rules applicable to the other desktop agent. In some implementations, the configurable rules for desktop agents in a particular cloud region (e.g., the cloud region 220) are the same but are different from configurable rules for desktop agents in a second cloud region (e.g., the cloud region 212(1)). Similarly, configurable rules for gateway agents may be the same for a particular cloud region but different for gateway agents in a different cloud region. Furthermore, configurable rules between desktop agents and gateway agents within the same cloud region may be different. Thus, the configurable rules can be customized at different levels allowing uniformity by cloud region, by groups of customers, by type of agent, etc.

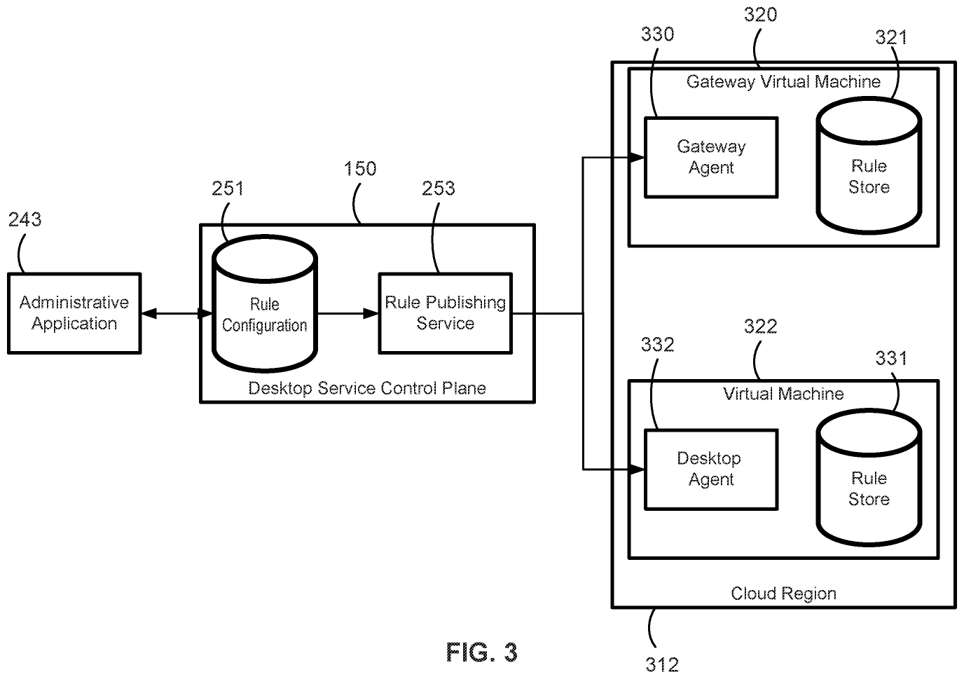

Some implementations of the present disclosure provide methods of publishing rules to different agents. FIG. 3 shows a flow diagram for providing rules to a gateway agent 330 and a desktop agent 332 in a cloud region 312, according to some implementations of the present disclosure. FIG. 3 shows a system which is similar to or the same as the system 200. The system 300 is simplified to facilitate discussion of the different aspects of the rule publishing method. The administrative application 243 is an application associated with the administration center 214 (FIG. 2) that allows the administrative user 242 (FIG. 2) to customize the configurable rules. The desktop service control plane 150 includes a rule configuration 251 referring to stored parameters and settings associated with the configurable rules customized via the administrative application 243.

The desktop service control plane 150 includes a rule publishing service 253 that reads the settings embedded in the rule configuration 251 to properly disseminate appropriate rules to the gateway agent 330 and/or the desktop agent 332. The cloud region 312 is similar to or the same as the cloud region 212 (FIG. 2) and can be a private or a public cloud infrastructure. Thus, the gateway virtual machine 320 is similar to the protocol gateway 220 (FIG. 2), the gateway agent 330 similar to the gateway agent 230 (FIG. 2), the virtual machine 322 similar to the managed virtual desktop 222 (FIG. 2), and the desktop agent 332 similar to the desktop agent 232 (FIG. 2). The gateway virtual machine 320 includes a rule store 321 for storing configurable rules pertaining to management actions to be taken by the gateway agent 330. Similarly, the virtual machine 322 includes a rule store 331 for storing configurable rules pertaining to management actions to be taken by the desktop agent 332. The rule stores 321, 331 allow local storage of rules for ease of access of the respective agents, especially in situations where the control plane 150 is not accessible by the agents. The control plane 150 in FIG. 3 is simplified to highlight the rule publishing service 253 and the rule configuration 251.

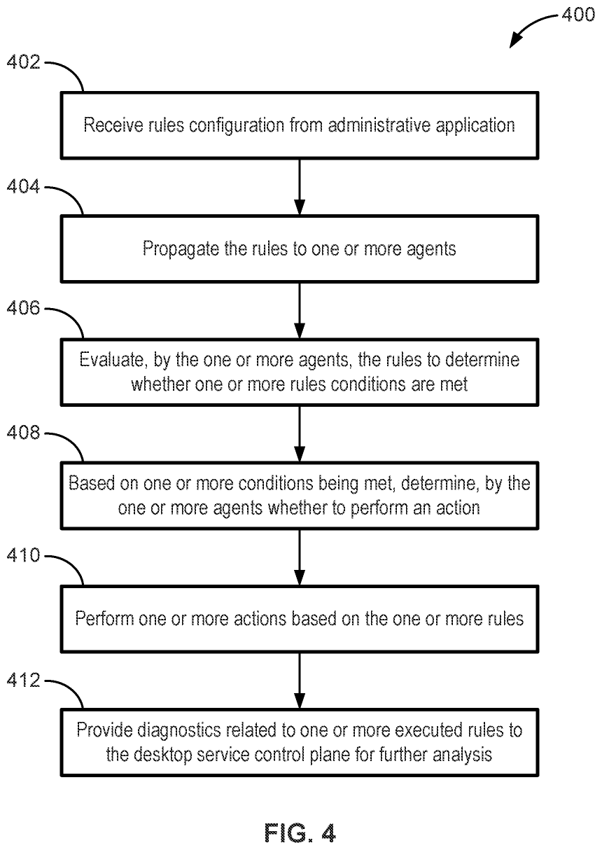

Referring to FIG. 4, a flow diagram providing a process 400 for managing events in the cloud region 312 is provided, according to some implementations of the present disclosure. The process 400 is cooperatively performed by the desktop service control plane 150 and the cloud region 312. Some steps in the process 400 are performed by the control plane 150 and some are performed by agents (e.g., the desktop agent 332, the gateway agent 330) of the cloud region 312. At step 402, the control plane 150 receives the rules configuration 251 from the administrative application 243. Administrators can configure the rules configuration 251 to target specific agents.

In some implementations, one or more rules in the rules configuration 251 can include three component parts. The component parts include a “When” component part, an “If” component part, and a “Then” component part. In the “When” component part, the administrative application 243 can define an event (or a triggering event). The event may be an occurrence that may be relevant to maintaining operational health of the virtual machine being managed (e.g., the gateway virtual machine 320, the virtual machine 322, etc.).

The “If” part of the rule can be represented by functional expression syntax for evaluating some current condition associated with the virtual machine being managed. For example, the functional expression syntax can evaluate a current operational health associated with the virtual machine in order to block further execution if the conditions do not warrant action being taken. The functional expression syntax of the “If” part of the rule can be similar or the same as the conditional expression syntax of a known programming or scripting language. The syntax may be defined as a set of expressions that when combined can always be evaluated as a Boolean value (e.g., 1 or 0, “True” or “False”) at the time the rule is evaluated. In some implementations, logical operators are introduced into the syntax, so that individual expressions may be combined logically so that all expressions must be true (usually indicated by the “AND” operator), or at least one must be true (usually indicated by the “OR” operator). Other operators that may be included in the syntax are precedence operators (for logical grouping of nested expressions), binary operators such as equality or inequality operators, etc.

The “Then” component part of a rule may include a series of functional statements that cause specific actions to take place in the execution environment of the agent managing the virtual machine. These specific actions can be diagnostic and/or healing actions to mitigate effect of errors or other virtual machine states identified via the “If” component part.

A rule providing the three component parts is merely provided as an example, and other rule structures may be provided in other contexts. For example, another rule structure may include an “Else” component part linked to the “If” component part. The “Else” component part includes actions taken if evaluation of the functional expression syntax of the “If” component part is evaluated to “False.” Rules can be set for maintaining driver versions of hardware components (e.g., maintaining GPU driver version), checking performance metrics to raise alerts when networks perform poorly, etc.

At step 404, the control plane 150 propagates the configured rules to one or more agents. For example, the rule publishing service 253 deploys the configured rules to the desktop agent 332 and/or the gateway agent 330. In some implementations, as rules are updated by the administrative application 243, the updated rules are deployed to the desktop agent 332 and/or the gateway agent 330. The rules configuration 251 can categorize rules by cloud region, by groups of customers, by groups of virtual machines (e.g., virtual machines having access to specific applications, virtual machines running on specific servers thus having specific hardware, gateway virtual machines, desktop virtual machines, etc.). Organizing the rules in the rules configuration 251 allows the rule publishing service 253 to quickly or easily deploy rules to applicable agents. The deployed rules are stored in rule stores 321, 331. In some implementations, the rule configuration 251 stores a first configurable set of rules which is a combination of a second configurable set of rules and a third configurable set of rules. After deployment, the second configurable set of rules are copied and stored in the rule store 321 and the third configurable set of rules are copied and stored in the rule store 331.

At step 406, the rules stored in the rule stores 321, 331 are evaluated by the one or more agents (e.g., the desktop agent 332, the gateway agent 330) to determine whether one or more rules conditions are met. In some implementations, the agents continuously check to see whether the one or more rules conditions are met. In some implementations, the agents periodically check to see whether the one or more rules conditions are met. In some implementations, the timing associated with the evaluation is dependent on the rule itself. For example, the rule may include timing parameters that instruct the agent when check whether the one or more rules conditions are met.

In some implementations, at step 406, events or triggering events are identified by the agent. Events can be any detectable occurrence that is relevant to an agent in monitoring and maintaining health of a virtual machine. For illustrative purposes, Table 1 lists and explains four examples of events that could be useful in triggering rules, according to some implementations of the present disclosure.

TABLE 1
Example Events

| Event | Details |
|---|---|
| scheduledEvent | Some periodic or specified time has arrived |
| connectivityEvent | A change in connectivity status has occurred |
| registryEvent | The configuration registry has been modified |
| powerEvent | A change or request to change power status |
| | has occurred. |
| versionEvent | A new version or patch release is available for |
| | a component |
| performanceEvent | An unusual performance result has been obtained |
| | from a monitoring service |

At step 408, based on one or more rules conditions being met, the agent(s) determine whether to perform an action. In some implementations, actions to be performed upon rules conditions being met are included in the “Then” component part of the rule. Thus, existence of parameters or defined actions in the “Then” component part of the rule indicates to the agent that an action is to be performed.

At step 410, the agent performs one or more actions based on the prescribed action in the rule. In some implementations, actions taken can be coordinated or ordered. For example, if two rules conditions are met and actions associated with the two rules are to be taken, an order or priority associated with the rules lets the agent know which actions should be executed first. Examples of actions that can be performed include raising an alert, rebooting a machine, changing a registry, powering down a machine or a computing system, starting or stopping a process or service, changing a configuration file, or any combination thereof.

In some implementations, to evaluate whether a rule should be executed or not once the event has occurred, an existing or a newly devised functional syntax is used to obtain additional information from, and take action within, the agent. For example, Table 2 provides some example functions that can be invoked within the context of a rule to obtain information about, or update status of, the virtual machine. In some cases, some of these functions may be used to send information to the desktop service control plane 150.

TABLE 2
Example Functions

| Function | Details |
|---|---|
| raiseAlert(alert) | Send an alert event to the desktop service |
| | control plane, as well as logging the alert |
| | locally |
| getHealthScore( ) | Run health check and get gateway health |
| | metric |
| getHealthDetails( ) | Obtain latest full report of health check |
| getConnectionStatus(service) | Obtain current connection status of a |
| | service |
| getNumDesktopSessions( ) | Obtain current number of active remote |
| | desktop sessions |
| getRegistryValue(key) | Obtain the current value of the registry |
| | key |
| setRegistryValue(key, value) | Update the registry for one key |
| getPowerStatus( ) | Obtain the current power status of the |
| | machine |
| invokeScript(script) | Execute a script by name |
| updateVersion( ) | Trigger automatic update of a component |

At step 412, the agent provides diagnostics related to the one or more executed rules to the desktop service control plane 150 for further analysis. The diagnostics can include the specific conditions that caused the rule evaluation, the actions taken, and results and status of the virtual machine after the actions have been taken.

Some examples of rules that can incorporate the functions provided above in Table 2 are provided in Table 3.

TABLE 3
Example Rules

| Example Rule | | | | |
|---|---|---|---|---|
| Target | | | | |
| Category | Details | “When” | “If” | “Then” |
| Health Check | If a configured health | scheduledEvent | getHealthScore( ) < 50 | raiseAlert(“health |
| Services. | check detects | | | alert”, |
| | problems, proactively | | | getHealthScore( ), |
| | notify the control | | | getHealthDetails( )) |
| | plane. | | | |
| Networking | If the DNS service | connectivityEvent | getConnectivityStatus(‘DNS’) == | raiseAlert( ), |
| Services | goes down, if the | | NotConnected AND | resetService(‘DNS’) |
| | virtual machine is not | | getNumDesktopSessions( ) == 0 | |
| | currently in use, reset | | | |
| | the DNS service on | | | |
| | the virtual machine to | | | |
| | attempt restoration | | | |
| Power | If some user or policy | registryEvent | getRegistry Event( ).getType( ) == | setRegistry Value |
| Management | has turned on power | | Registry Update AND | (‘power-save- |
| Services | saving, that can | | getRegistryEvent.getKey( ) == | mode’, ‘0’), |
| | conflict with agent | | ‘power-save-mode’ AND | raiseAlert (‘power- |
| | operation, force | | getRegistryValue('power-save-mode') == | save-override’) |
| | power saving off. | | ‘1’ | |
| System | If some user or other | powerEvent | getPowerStatus( ) == | raiseAlert |
| Operations | agent is powering | | User_shutdown_request | (‘shutdown |
| | down the machine, | | | request’), |
| | raise an alert to the | | | invokeScript |
| | control plane and run | | | (“powerdown.ps”) |
| | a custom script. | | | |
| System | If statistics reporting | connectivityEvent | getMetricsStatus( ) == false | clearCache( ) |
| Operations | fails due to a local | | | |
| | communication | | | |
| | service failure, | | | |
| | attempt to repair by | | | |
| | clearing the cache | | | |
| Versioning | If a new version of a | upgradeEvent | getVersion( ) < | updateVersion(component) |
| | component is | | getLatestVersion( ) | |
| | available, trigger an | | | |
| | upgrade | | | |
| Network | Raise alert if | performanceEvent | getPerformance( ) > threshold | raiseAlert(‘performance |
| Performance | performance is below | | | warning’) |
| | expected | | | |

In Table 3, events and functional expressions described in Tables 1 and 2, respectively, can be combined to create rules for managing virtual machines. The examples in Table 3 are merely illustrative pseudo-code describing activities that can be undertaken by agents. Other or more expansive language features, such as variables, namespaces, string operations, or other capabilities of programming or scripting systems can be incorporated for finer control and management tasks. Rules can be designed to deal with health checks, DNS service status, triggering on power savings, powering down computing infrastructure, maintaining driver versions, network performance, or any other maintenance activity that can be distilled to logic expressed in a programming or scripting format.

As discussed in connection with FIG. 3, in some implementations, the rule configuration 251 stores a first configurable set of rules which is a combination of a second configurable set of rules and a third configurable set of rules. The second configurable set of rules can be copied and stored in the rule store 321 for use by the gateway agent 330, and the third configurable set of rules can be copied and stored in the rule store 331 for use by the desktop agent 332. As an example, the powerEvent example rule in Table 3 is a rule that would be included in the third configurable set of rules and not in the second configurable set of rules. Similarly, the connectivityEvent example rule in Table 3 is a rule that would be included in the second configurable set of rules and not in the third configurable set of rules.

For example, the desktop user 240 (FIG. 2) is connected to the virtual machine 332 and is attempting to initiate a shutdown of the virtual machine from the operating system of the virtual machine. The desktop agent 332 can raise an alert (e.g., “shutdown request” alert) to the control plane 150 indicating that the desktop user 240 may have successfully found a combination of steps to initiate the shutdown process. The desktop agent 332 can further run a custom script (e.g., “powerdown.ps1”) to prevent shutdown of the virtual machine. Because the desktop user 240 has some control over behavior of applications and services in the virtual machine 322 to be able to complete desired tasks, administrators typically allow users some freedom in changing some settings in the virtual machine.

Administrators typically allow changes to settings that will foster personalization, while disabling access to system-level or operating system-level settings. Cloud administrators will typically remove the option for users to shutdown virtual machines, and if a user were able to find a workaround, the “shutdown request” alert provided to the control plane 150 can alert administrators to a certain workaround not properly blocked. Even though the desktop user 240 does not successfully shutdown the virtual machine because of the “powerdown.ps1” script, administrators may find it valuable to know that an unblocked workaround exists. Due to this rule being directed to user behavior, and the user typically interacts with applications via the virtual machine 322, the powerEvent example rule in Table 3 is therefore a rule that would be stored in the rule store 331 for use by the desktop agent 332 and would not be a useful rule to provide to the gateway agent 330.

In contrast, the connectivityEvent example rule under the network services category in Table 3 is a rule that would be beneficial in the gateway virtual machine 320 but may not as beneficial in the virtual machine 322. For example, the connectivityEvent example rule in Table 3 deals with an unresponsive DNS service on the gateway virtual machine 320. A DNS service is especially critical to allow reaching networked computing devices using a domain name. From the example rule, if the DNS service goes down, and if the gateway virtual machine 320 is not currently in use, the gateway agent 330 can reboot the gateway virtual machine 320 to attempt restoration of the DNS service. In some implementations, instead of rebooting the gateway virtual machine 320, the gateway agent 330 can reset the DNS service to see whether that resolves the issue. Rules having to do with rebooting the gateway virtual machine 320 would not be useful to the desktop agent 332 because the desktop virtual machine may rely less on DNS for connectivity.

In some implementations, the connectivityEvent example rule can be tweaked for the virtual machine 322 to deal with cases where issues relating to the unresponsive DNS service may be related to an error encountered in the operating system of the virtual machine 322. In that case, the desktop agent 332 can restart the virtual machine 322. These rules examples illustrate that rules can be tailored to specific virtual machines (e.g., gateway virtual machines vs. desktop virtual machines), and in some cases can be based on specific applications and services accessible in the virtual machines.

In some implementations, the scheduledEvent example rule in Table 3 is a rule that can be included in both the second configurable set of rules and the third configurable set of rules. For example, each of the gateway virtual machine 320 and the virtual machine 322 can include a health check program that provides health scores. The health check program can, for example, evaluate available resources like virtual storage, virtual RAM, network connectivity, etc., and provide a health score. The health score can be checked against a health score threshold to determine whether to raise a health alert to the control plane 150 and provide, along with the health alert, the determined health score and details regarding components of the health score.

Similarly, in some implementations, the registryEvent example rule in Table 3 is a rule that can be included in both the second configurable set of rules and the third configurable set of rules. For example, the gateway virtual machine 320 can include a power-saver policy setting for reducing power consumption in order to adhere to a green policy campaign. The power-saver policy can turn on a power-save-mode by updating a registry value of “power-save-mode” from “0” to “1.” If the power-save-mode will conflict with the operation of the gateway agent 330, then the gateway agent can override the power-saver policy and set the registry value back to “0.” The power-saver policy can raise an alert to the control plane 150 to make the control plane 150 aware that the power-saver policy has been overridden. This rule can be beneficial for the virtual machine 322 as well because instead of, or in addition to, the power-saver policy setting the power profile, the user 240 may change to the power-save-mode, and the desktop agent 332 can override the user 240 as well.

In some implementations, the system metrics reporting example rule in Table 3 is a rule that can be included in both the second configurable set of rules and the third configurable set of rules. If reporting of system metrics to the control plane 150 has failed due to a problem with a communication service running on the virtual machine where the agent is running, the agent (e.g. the gateway agent 320 or desktop agent 332) may attempt to restore the metrics reporting by clearing the cache of a communications service upon which metrics reporting relies.

In some implementations, the upgradeEvent example rule in Table 3 is a rule that can be included in both the second configurable set of rules and the third configurable set of rules. If a new version of a component is available, the agent (e.g., the gateway virtual machine 320) can trigger an upgrade. Examples of version upgrades include upgrading driver versions (e.g., GPU driver versions), upgrading software applications (e.g., providing access to a most recent software version of an application that the user relies upon), etc.

In some implementations, the performanceEvent example rule in Table 3 is a rule that can be used to trigger alerts when network performance is greater an expected threshold. For example, if latency of the network exceeds a threshold, then an alert can be triggered. The performanceEvent can be used independently of rules targeting health check services. For example, health check services may target optimizing an overall health score, while performanceEvent may be used to target a specific criteria like networking.

In some implementations, all alerts raised by the one or more rules are provided in step 412 because the alerts may include specific diagnostics related to the executed rules. For example, in relation to the scheduledEvent example of Table 3, health details indicating the components of the health score can be provided with the health alert in step 412.

It is difficult to diagnose, troubleshoot, and repair virtual machines if (a) agents running on those virtual machines are unable to communicate with the desktop service control plane, or (b) agents do not handle problems recently discovered and allow those problems to accumulate over time. Cloud desktop service support staff can spend a long time troubleshooting and/or diagnosing problems with virtual machines. Usually, once diagnosed, the actions to be taken are typically well understood. Embodiments of the present disclosure provide a distributed rule-based diagnostic and repair system in a cloud-based system to provision gateways and desktop virtual machines to be maintained with a higher level of reliability, even when network communication with the desktop service control plane is unreliable. Advantages of the distributed rule-based diagnostic and repair system include (i) agent diagnostic and repair operations being more quickly implemented through rules to avoid the need for software upgrades of the agent, (ii) repair operations occurring automatically without the need for centralized commands and communication from the desktop service control plane, (iii) time to repair is reduced, (iv) preventative operations can be performed to minimize disruptions and other impacts to user experience, etc.

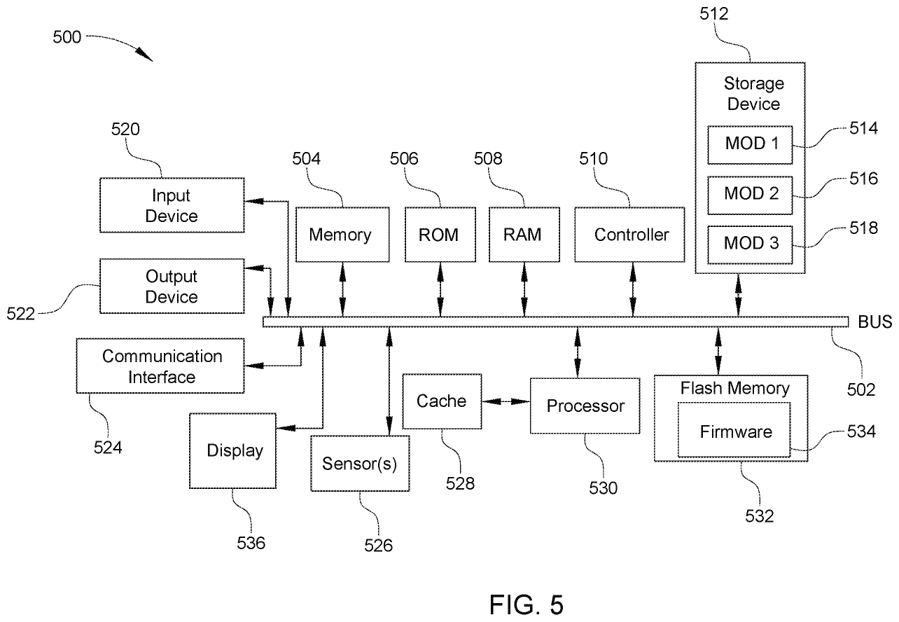

FIG. 5 illustrates an example computing system 500, in which the components of the computing system are in electrical communication with each other using a bus 502. The system 500 includes a processing unit (CPU or processor) 530 and a system bus 502 that couple various system components, including the system memory 504 (e.g., read only memory (ROM) 506 and random access memory (RAM) 508), to the processor 530. The system 500 can include a cache of high-speed memory connected directly with, in close proximity to, or integrated as part of the processor 530. The system 500 can copy data from the memory 504 and/or the storage device 512 to the cache 528 for quick access by the processor 530. In this way, the cache can provide a performance boost for processor 530 while waiting for data. These and other modules can control or be configured to control the processor 530 to perform various actions. Other system memory 504 may be available for use as well. The memory 504 can include multiple different types of memory with different performance characteristics. The processor 530 can include any general purpose processor and a hardware module or software module, such as module 1 514, module 2 516, and module 3 518 embedded in storage device 512. The hardware module or software module is configured to control the processor 530, as well as a special-purpose processor where software instructions are incorporated into the actual processor design. The processor 530 may essentially be a completely self-contained computing system that contains multiple cores or processors, a bus, memory controller, cache, etc. A multi-core processor may be symmetric or asymmetric.

To enable user interaction with the computing device 500, an input device 520 is provided as an input mechanism. The input device 520 can comprise a microphone for speech, a touch-sensitive screen for gesture or graphical input, keyboard, mouse, motion input, and so forth. In some instances, multimodal systems can enable a user to provide multiple types of input to communicate with the system 500. In this example, an output device 522 is also provided. The communications interface 524 can govern and manage the user input and system output.

Storage device 512 can be a non-volatile memory to store data that is accessible by a computer. The storage device 512 can be magnetic cassettes, flash memory cards, solid state memory devices, digital versatile disks, cartridges, random access memories (RAMs) 508, read only memory (ROM) 506, and hybrids thereof.

The controller 510 can be a specialized microcontroller or processor on the system 500, such as a BMC (baseboard management controller). In some cases, the controller 510 can be part of an Intelligent Platform Management Interface (IPMI). Moreover, in some cases, the controller 510 can be embedded on a motherboard or main circuit board of the system 500. The controller 510 can manage the interface between system management software and platform hardware. The controller 510 can also communicate with various system devices and components (internal and/or external), such as controllers or peripheral components, as further described below.

The controller 510 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 510 to initiate or conduct specific hardware recovery procedures or operations, as further described below.

The controller 510 can also include a system event log controller and/or storage for managing and maintaining events, alerts, and notifications received by the controller 510. For example, the controller 510 or a system event log controller can receive alerts or notifications from one or more devices and components, and maintain the alerts or notifications in a system event log storage component.

Flash memory 532 can be an electronic non-volatile computer storage medium or chip that can be used by the system 500 for storage and/or data transfer. The flash memory 532 can be electrically erased and/or reprogrammed. Flash memory 532 can include EPROM (erasable programmable read-only memory), EEPROM (electrically erasable programmable read-only memory), ROM, NVRAM, or CMOS (complementary metal-oxide semiconductor), for example. The flash memory 532 can store the firmware 534 executed by the system 500 when the system 500 is first powered on, along with a set of configurations specified for the firmware 534. The flash memory 532 can also store configurations used by the firmware 534.

The firmware 534 can include a Basic Input/Output System or equivalents, such as an EFI (Extensible Firmware Interface) or UEFI (Unified Extensible Firmware Interface). The firmware 534 can be loaded and executed as a sequence program each time the system 500 is started. The firmware 534 can recognize, initialize, and test hardware present in the system 500 based on the set of configurations. The firmware 534 can perform a self-test, such as a POST (Power-On-Self-Test), on the system 500. This self-test can test the functionality of various hardware components such as hard disk drives, optical reading devices, cooling devices, memory modules, expansion cards, and the like. The firmware 534 can address and allocate an area in the memory 504, ROM 506, RAM 508, and/or storage device 512, to store an operating system (OS). The firmware 534 can load a boot loader and/or OS, and give control of the system 500 to the OS.

The firmware 534 of the system 500 can include a firmware configuration that defines how the firmware 534 controls various hardware components in the system 500. The firmware configuration can determine the order in which the various hardware components in the system 500 are started. The firmware 534 can provide an interface, such as an UEFI, that allows a variety of different parameters to be set, which can be different from parameters in a firmware default configuration. For example, a user (e.g., an administrator) can use the firmware 534 to specify clock and bus speeds, define what peripherals are attached to the system 500, set monitoring of health (e.g., fan speeds and CPU temperature limits), and/or provide a variety of other parameters that affect overall performance and power usage of the system 500. While firmware 534 is illustrated as being stored in the flash memory 532, one of ordinary skill in the art will readily recognize that the firmware 534 can be stored in other memory components, such as memory 504 or ROM 506.

System 500 can include one or more sensors 526. The one or more sensors 526 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 526 can communicate with the processor, cache 528, flash memory 532, communications interface 524, memory 504, ROM 506, RAM 508, controller 510, and storage device 512, via the bus 502, for example. The one or more sensors 526 can also communicate with other components in the system via one or more different means, such as inter-integrated circuit (I2C), general purpose output (GPO), and the like. Different types of sensors (e.g., sensors 526) on the system 500 can also report to the controller 510 on parameters, such as cooling fan speeds, power status, operating system (OS) status, hardware status, and so forth. A display 536 may be used by the system 500 to provide graphics related to the applications that are executed by the controller 510.

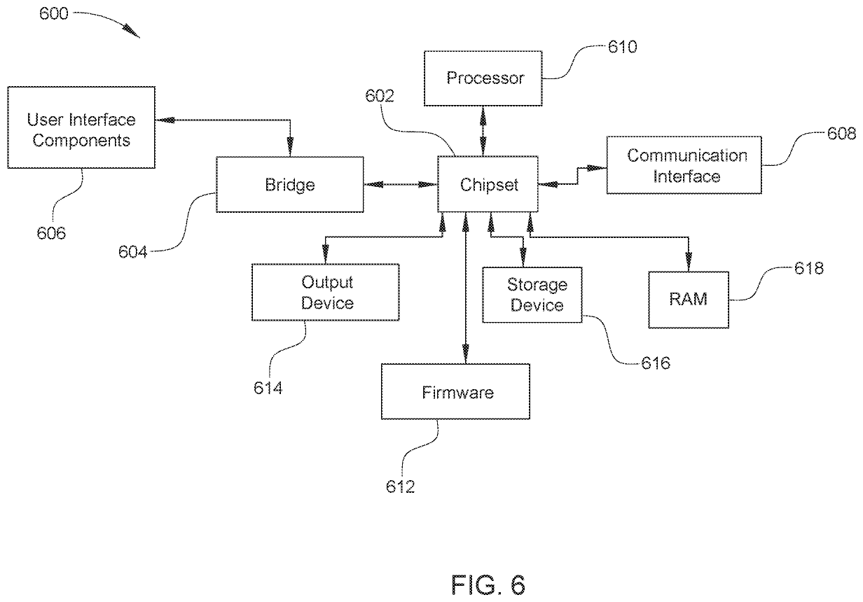

FIG. 6 illustrates an example computer system 600 having a chipset architecture that can be used in executing the described method(s) or operations, and generating and displaying a graphical user interface (GUI). Computer system 600 can include computer hardware, software, and firmware that can be used to implement the disclosed technology. System 600 can include a processor 610, representative of a variety of physically and/or logically distinct resources capable of executing software, firmware, and hardware configured to perform identified computations. Processor 610 can communicate with a chipset 602 that can control input to and output from processor 610. In this example, chipset 602 outputs information to output device 614, such as a display, and can read and write information to storage device 616. The storage device 616 can include magnetic media, and solid state media, for example. Chipset 602 can also read data from and write data to RAM 618. A bridge 604 for interfacing with a variety of user interface components 906, can be provided for interfacing with chipset 602. User interface components 606 can include a keyboard, a microphone, touch detection, and processing circuitry, and a pointing device, such as a mouse.

Chipset 602 can also interface with one or more communication interfaces 608 that can have different physical interfaces. Such communication interfaces can include interfaces for wired and wireless local area networks, for broadband wireless networks, and for personal area networks. Further, the machine can receive inputs from a user via user interface components 606, and execute appropriate functions, such as browsing functions by interpreting these inputs using processor 610.

Moreover, chipset 602 can also communicate with firmware 612, which can be executed by the computer system 600 when powering on. The firmware 612 can recognize, initialize, and test hardware present in the computer system 900 based on a set of firmware configurations. The firmware 612 can perform a self-test, such as a POST, on the system 600. The self-test can test the functionality of the various hardware components 602-618. The firmware 612 can address and allocate an area in the memory 618 to store an OS. The firmware 612 can load a boot loader and/or OS, and give control of the system 600 to the OS. In some cases, the firmware 612 can communicate with the hardware components 602-610 and 614-618. Here, the firmware 612 can communicate with the hardware components 602-610 and 614-618 through the chipset 602, and/or through one or more other components. In some cases, the firmware 612 can communicate directly with the hardware components 602-610 and 614-618.

It can be appreciated that example systems 500 (in FIG. 5) and 600 can have more than one processor (e.g., 530, 610), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A virtual desktop system comprising:
one or more virtual desktops and associated public or private cloud infrastructure; and
a control plane configured to manage a life cycle of the one or more virtual desktops on the cloud infrastructure, the cloud infrastructure being configured to:
(i) receive a first configurable set of rules from the control plane,
(ii) store the first configurable set of rules,
(iii) evaluate the first configurable set of rules to determine whether conditions associated with one or more rules are met,
(iv) based on the conditions being met, perform one or more actions to execute the one or more rules, and
(v) provide diagnostics related to the one or more executed rules to the control plane for further analysis.

2. The system of claim 1, wherein the cloud infrastructure includes at least one gateway virtual machine having a gateway agent, the gateway agent being configured to perform steps (i) through (v).

3. The system of claim 2, wherein steps (iii) through (iv) are performed when the gateway agent loses connectivity to the control plane.

4. The system of claim 2, wherein the first configurable set of rules includes a second configurable set of rules defining rules for the gateway agent and a third configurable set of rules defining rules for a desktop agent, and wherein step (ii) involves:
storing, by the gateway agent in the gateway virtual machine, only the second configurable set of rules.

5. The system of claim 1, wherein the one or more virtual desktops include at least one desktop agent, the desktop agent being configured to perform steps (i) through (v).

6. The system of claim 5, wherein steps (iii) through (iv) are performed when the desktop agent loses connectivity to the control plane.

7. The system of claim 5, wherein the first configurable set of rules includes a second configurable set of rules defining rules for a gateway agent and a third configurable set of rules defining rules for the desktop agent, and wherein step (ii) involves:
storing, by the desktop agent in the one or more virtual desktops, only the third configurable set of rules.

8. The system of claim 1, wherein the first configurable set of rules are defined by an administrative user.

9. The system of claim 1, wherein the cloud infrastructure performing step (iv) involves:
determining that one or more events has occurred, the one or more events including (a) a scheduled time has arrived, (b) a change in connectivity status between the control plane and the cloud infrastructure has occurred, (c) a modification of a configuration registry, (d) a change of a power status, (e) a request to change the power status, or (f) any combination thereof.

10. The system of claim 1, wherein the one or more rules include: (a) a rule associated with a health check, (b) a rule associated with a status of a networking service, (c) a rule associated with a power management service, (d) a rule associated with system operations, (e) a rule associated with versioning, (f) a rule associated with network performance, or (g) any combination thereof.

11. The system of claim 1, wherein the one or more actions are included in the one or more rules.

12. The system of claim 11, wherein the one or more actions include: (a) raising an alert, (b) rebooting, (c) changing a registry value, (d) powering down a computing system, (e) starting or stopping a process or service, (f) changing a configuration file, (g) clearing a cache, or (h) any combination thereof.

13. A method for managing a virtual desktop, the method comprising:
(i) receiving, by a public or private cloud infrastructure associated with the virtual desktop, a first configurable set of rules from a control plane,
(ii) storing, by the cloud infrastructure, the first configurable set of rules,
(iii) evaluating, by an agent of the cloud infrastructure, the first configurable set of rules to determine whether conditions associated with one or more rules are met,
(iv) based on the conditions being met, performing, by the agent, one or more actions to execute the one or more rules, and
(v) providing, by the agent, diagnostics related to the one or more executed rules to the control plane for further analysis.

14. The method of claim 13, wherein:
the agent is one of a desktop agent associated with the virtual desktop or a gateway agent associated with a gateway virtual machine.

15. The method of claim 14, wherein the first configurable set of rules includes a second configurable set of rules defining rules for the gateway agent and a third configurable set of rules defining rules for the desktop agent.

16. The method of claim 15, wherein step (ii) involves:
storing, by the gateway agent in the gateway virtual machine, only the second configurable set of rules; and
storing, by the desktop agent in the virtual desktop, only the third configurable set of rules.

17. The method of claim 13, wherein steps (iii) through (iv) are performed when the agent loses connectivity to the control plane.

18. The method of claim 13, further comprising:
determining that one or more events has occurred, the one or more events including (a) a scheduled time has arrived, (b) a change in connectivity status between the control plane and the cloud infrastructure has occurred, (c) a modification of a configuration registry, (d) a change of a power status, (e) a request to change the power status, or (f) any combination thereof

19. The method of claim 13, wherein the one or more rules include: (a) a rule associated with a health check, (b) a rule associated with a status of a networking service, (c) a rule associated with a power management service, (d) a rule associated with system operations, (e) a rule associated with versioning, (f) a rule associated with network performance, or (g) any combination thereof.

20. A non-transitory computer-readable medium having machine-readable instructions stored thereon, which when executed by a processor, cause the processor to:
(i) receive, by a public or private cloud infrastructure associated with a virtual desktop, a first configurable set of rules from a control plane,
(ii) store, by the cloud infrastructure, the first configurable set of rules,
(iii) evaluate, by an agent of the cloud infrastructure, the first configurable set of rules to determine whether conditions associated with one or more rules are met,
(iv) based on the conditions being met, perform, by the agent, one or more actions to execute the one or more rules, and
(v) provide, by the agent, diagnostics related to the one or more executed rules to the control plane for further analysis.
